(19) United States
(12) Patent Application Publication
(10) Pub. No.: US 2026/0053299 A1
(43) Pub. Date: Feb. 26, 2026

(54) Utensil Rest

(71) Applicant: Leopoldo Marcelo Andal, Pembroke Pines, FL (US)

(72) Inventor: Leopoldo Marcelo Andal, Pembroke Pines, FL (US)

(21) Appl. No.: 18/810,202

(22) Filed: Aug. 20, 2024

(51) Int. Cl. A47J 47/16

(52) U.S. Cl. CPC A47J 47/16

(57) ABSTRACT

Modified utensil rest that is used for holding various utensils from kitchen to grilling utensils. The product is constructed using metal to prevent melting or disfiguration from exposure to extreme heat due to a grill or open flame. The primary feature includes a U-shaped channel which both holds utensils and prevents utensils from sliding or rolling off the bowl. Additionally, an elevated peak stemming from the channel is provided to raise utensils off the bowl preventing foodborne cross contamination. Finally, branching from the peak is a concave bowl to prevent leaks, drippings, and can optionally hold sauces and other liquids.

Be it known that I, Leopoldo M. Andal, citizen of the United States, have invented a new original and ornamental design for a UTENSIL REST of which the following is a specification, reference being has to the accompanying drawing forming a part thereof, wherein:

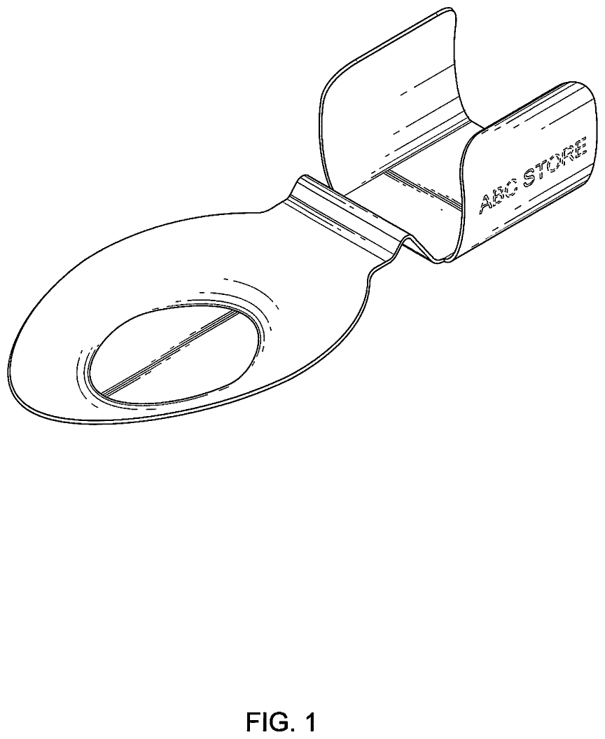

FIG. 1 is a perspective view of a utensil rest showing my new design, illustrating an optional logo in phantom outline;

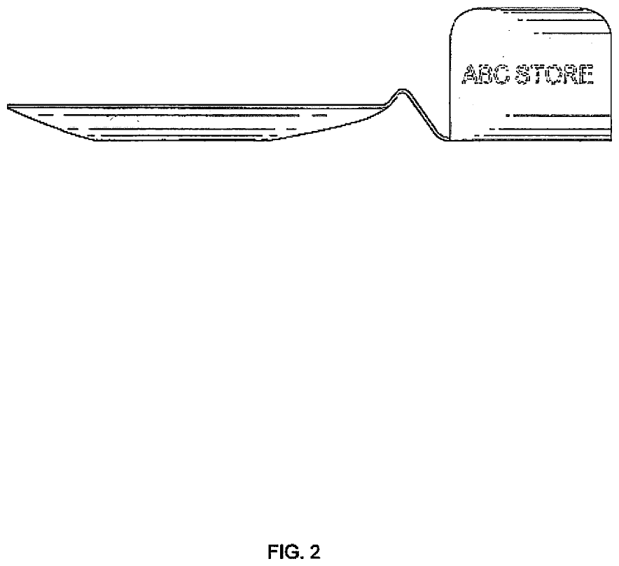

FIG. 2 is a right side view thereof, illustrating an optional logo in phantom outline;

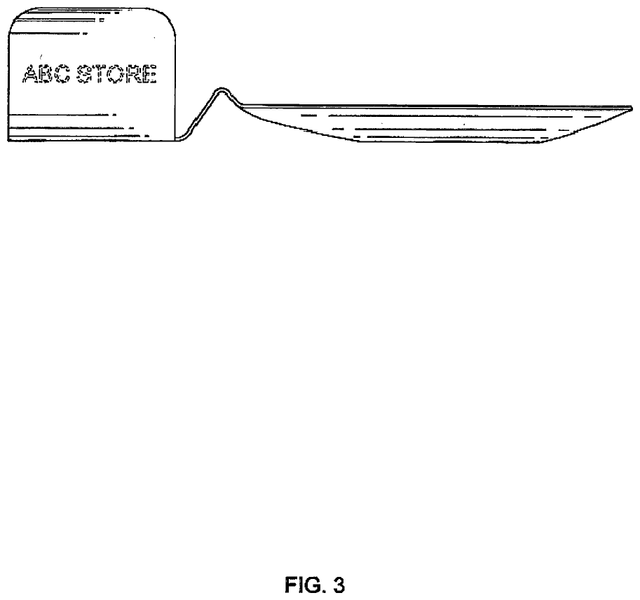

FIG. 3 is a left side view thereof, illustrating an optional logo in phantom outline;

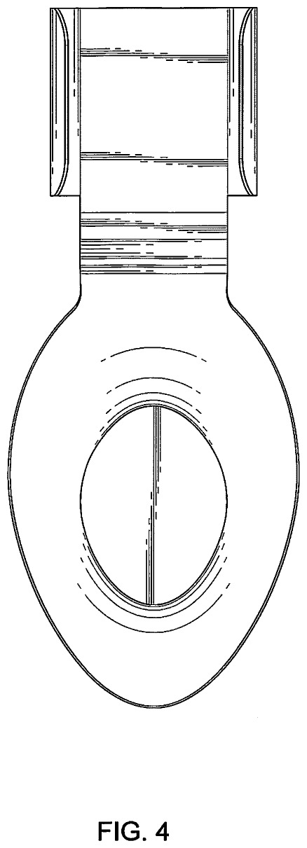

FIG. 4 is a top view thereof;

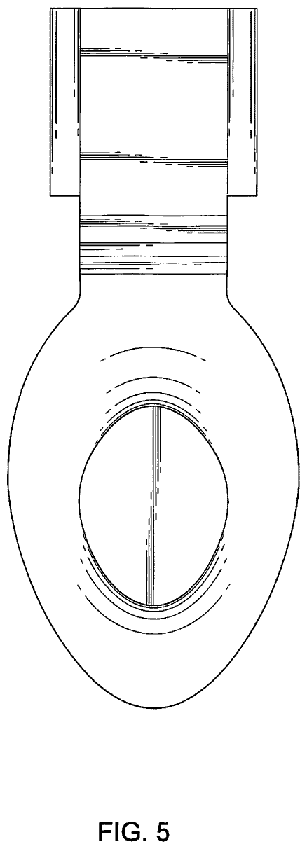

FIG. 5 is a bottom view thereof;

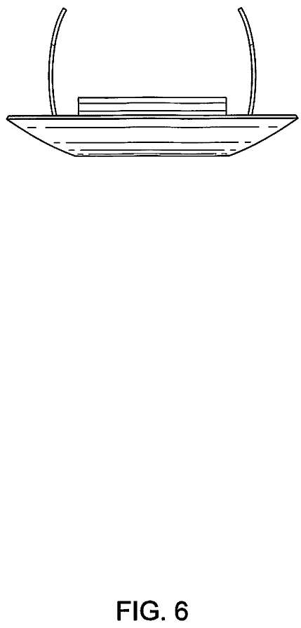

FIG. 6 is a front view thereof;

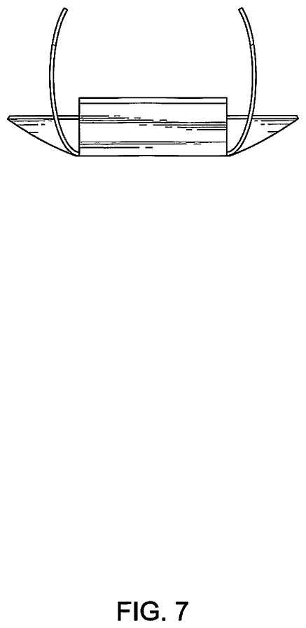

FIG. 7 is a back view thereof;

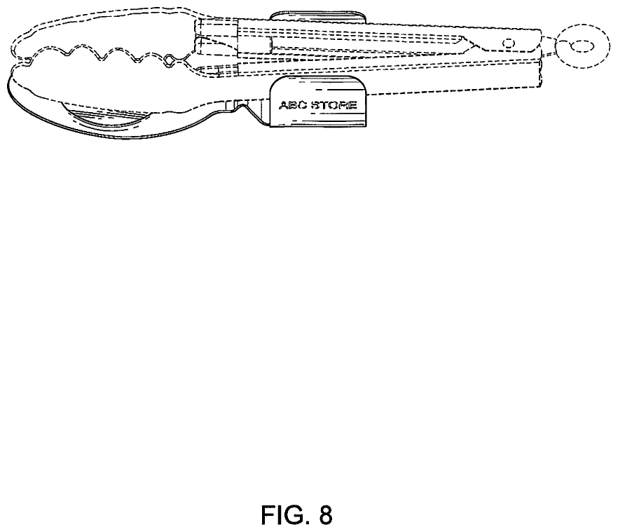

FIG. 8 is a perspective view thereof, illustrating an optional logo in phantom outline;

The broken line in the drawing illustrate the utensil which form no part of the claimed design.

The design show is not to be limited to any particular size and may be scaled larger or smaller.

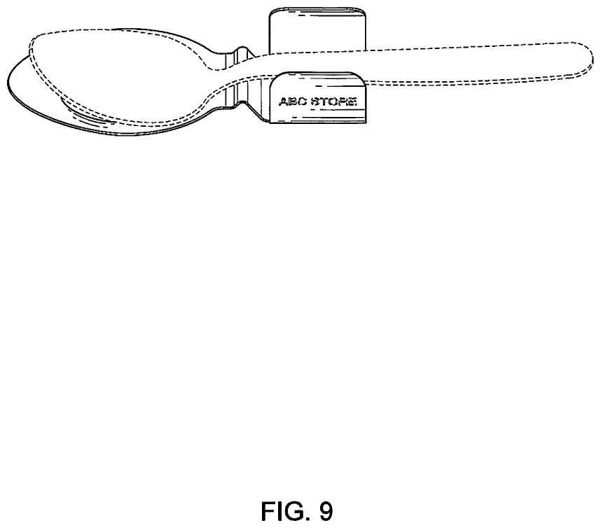

FIG. 9 is a perspective view thereof, illustrating an optional logo in phantom outline.

The broken line in the drawing illustrate the utensil which form no part of the claimed design.

The design show is not to be limited to any particular size and may be scaled larger or smaller.

1. I claim the ornamented design for a utensil rest, as shown and described.
